(19) United States
(12) Patent Application Publication
(10) Pub. No.: US 2003/0169385 A1
(43) Pub. Date: Sep. 11, 2003

(54) Illumination device for a color liquid crystal display

(75) Inventor: Daisaku Okuwaki, Yamanashi-ken (JP)

Correspondence Address: Ira J. Schultz, DENNISON, SCHULTZ & DOUGHERTY, 1745 Jefferson Davis Highway, Suite 612, Arlington, VA, 22202, US

(73) Assignee: Citizen Electronics Co., Ltd.

(21) Appl. No.: 10/377,768

(22) Filed: Mar. 4, 2003

(30) Foreign Application Priority Data
Mar. 5, 2002 (JP) 2002-59052

(51) Int. Cl. G02F 1/1335

(52) U.S. Cl. 349/65

(57) ABSTRACT

An illuminating device has an LED, a lighting panel provided corresponding to the LED for guiding light emitted from the LED to illuminate an LCD. An interference filter is provided on a surface through which the light from the LED passes so as to correct chromaticity of the light.

### BACKGROUND OF THE INVENTION

The present invention relates to an illumination device for illuminating a color liquid crystal display (LCD) as a front light.

An illumination device for the color LCD comprises a white LED and an illumination panel for illuminating the color LCD disposed below the illumination panel. In order to illuminate the LCD so that the LCD displays images with natural tone, it is necessary to balance the chromaticity of the white LED, the transmittance of the crystal in the LCD at every color, and the characteristic of a color filter provided in the LCD.

However, since it is difficult to adjust the transmittance of the crystal at every color, the chromaticity of the LED is adjusted.

FIG. 8 is a sectional view of a white LED. The white LED 50 comprises a substrate 51, a blue LED element 52 on the substrate 51 and a YAG fluorescent layer 53 covering the LED element 52. Blue light from the LED element 52 excites the YAG fluorescent layer to cause it to emit light yellow light. The blue light and light yellow light are mixed to produce white light.

FIGS. 9 through 13 are graphs showing spectrums of the light emitted from the white LED 50. The horizontal axis is the wave length (nm), the vertical axis is the relative intensity of the spectrum. In the graph, the red light has a wave length of about 625 nm, green light has a wave length of about 560 nm, and blue light has a wave length of about 450 nm.

FIG. 9 shows a spectrum H1 of normal white light emitted from the LED 50. The spectrums H2 and H3 of FIGS. 10 and 11 show lights of slightly blue, and H4 and H5 of FIGS. 12 and 13 show lights of slightly yellow.

FIG. 14 is a CIE chromaticity diagram showing the proportion of the chromaticity of the light emitted from the white LED. The X-axis shows the proportion of red, Y-axis shows the proportion of green and Z-axis shows the proportion of blue. There is a relationship of X+Y+Z=1. The point C0 at a central position is a point of the proportion of chromaticity of 1:1:1. The coordinate of the point C0 is X=0.33, Y=0.33 and Z=0.33. An area S surrounded by a dotted line is regarded as a white color range.

In order to provide a color LCD having a natural tone, it is necessary to provide LEDs with various chromaticities. However, the preparation of various LEDs increases the manufacturing cost.

### SUMMARY OF THE INVENTION

An object of the present invention is to provide an illumination device which is not necessary to prepare various LEDs.

According to the present invention, there is provided an illuminating device comprising an LED, a lighting panel provided corresponding to the LED for guiding light emitted from the LED to illuminate an LCD, and an interference filter provided on a surface through which the light from the LED passes so as to correct chromaticity of the light.

The device further comprising a light guide rod provided between the LED and the lighting panel so as to guide the light from the LED to the lighting panel.

The lighting panel is disposed above the LCD.

These and other objects and features of the present invention will become more apparent from the following detailed description with reference to the accompanying drawings.

### BRIEF DESCRIPTION OF DRAWINGS

FIG. 1 is a perspective view showing an illumination device according to a first embodiment of the present invention;

FIG. 2a is a perspective view of a light guide rod;

FIG. 2b is a sectional view showing a main part of the present invention;

FIG. 3 is a perspective view of a lighting panel;

FIG. 4 is a perspective view of another lighting panel;

FIG. 5 is a side view of the illumination device using the lighting panel of FIG. 3;

FIG. 6 is a side view of the illumination device using the lighting panel of FIG. 5;

FIG. 7 is a side view showing a second embodiment of the present invention;

FIG. 8 is a sectional view of a white LED;

FIGS. 9 through 13 are graphs showing spectrums of the light emitted from the white LED; and

FIG. 14 in a CIE chromaticity diagram showing the proportion of the chromaticity of the light emitted from the white LED.

### DETAILED DESCRIPTION OF THE PREFERRED EMBODIMENT

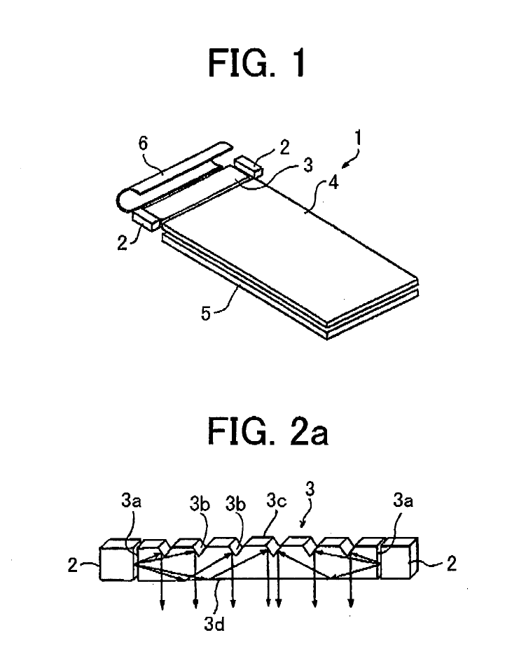

Referring to FIG. 1, an illumination device 1 comprises a light guide rod 3 made of a transparent resin, a pair of white LEDs 2 disposed at both ends of the light guide rod 3, an illuminating panel 4 made of a transparent resin disposed above a color LCD 5 as a front light and a reflector 6 disposed behind the light guide rod 3.

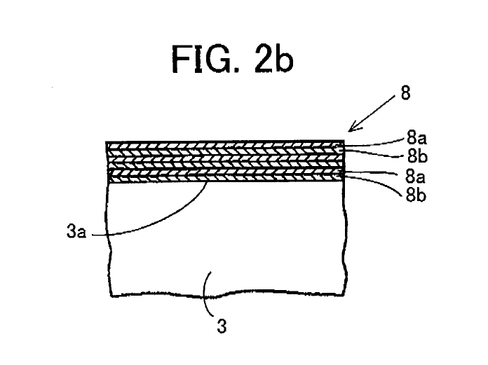

As shown in FIG. 2a, the white LED 2 is disposed corresponding to an incident end surface 3a. The guide rod 3 has a reflection surface 3c and a discharge surface 3d. A plurality of prisms 3b, each having a V-shaped groove are formed in the reflection surface 3c.

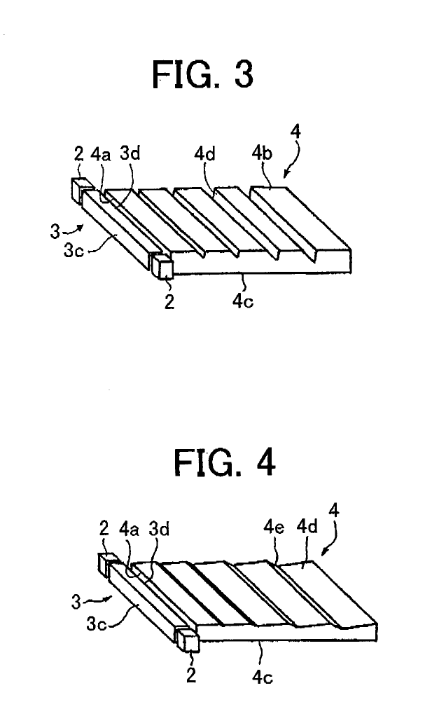

Referring to FIG. 3, the illuminating panel 4 has an incident surface 4a corresponding to the discharge surface 3d of the light guide rod 3, a reflection surface 4b, a discharge surface 4c. There is provided a plurality of prisms 4d, each having a V-shaped groove in the reflection surface 4b. In the illuminating panel 4 of FIG. 4, a plurality of prisms 4e, each having a step-like groove, are formed.

In accordance with the present invention, there is provided an interference filter 8 on at least one of transmitting incident and discharge surfaces 3a, 3d, 4a and 4c for transmitting or reflecting light of a predetermined wave length range by interference generated by membranes, thereby correcting the chromaticity of the light passing the surface. In the embodiment, the interference filter 8 is provided on the incident surface 3a as shown in FIG. 2b.

The interference filter 8 comprises a plurality of membranes 8a and 8b which are different from each other in refractive index and stacked alternately. The thickness of the membrane and the number of the membrane are selected so as to provide desired white light.

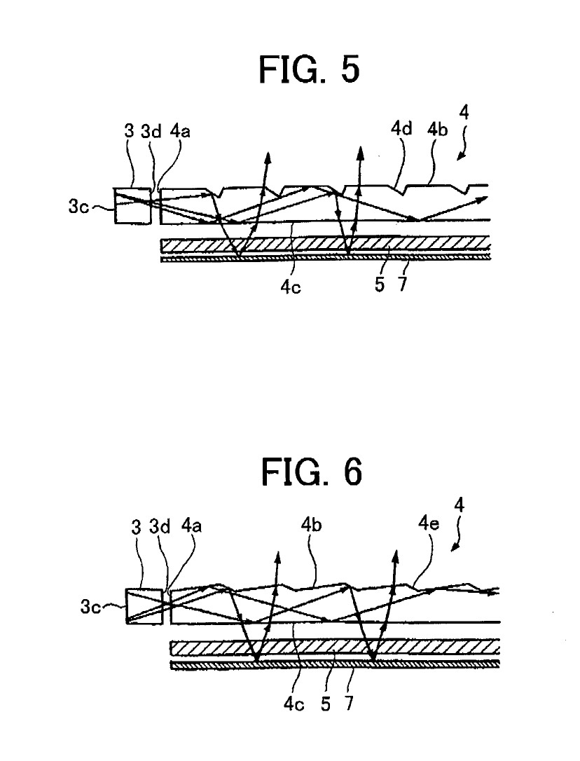

The lights emitted from the LEDs 2 enter the light guide rod 3 from the incident surface 3a through the interference filter 8. The color of the light emitted from the LEDs is corrected to proper white by the interference filter 8. As shown in FIG. 2a, the light in the light guide rod 3 is reflected by the prisms 3b and discharged from the discharge surface 3d. The discharged light enters in the lighting panel 4 from the incident surface 4a as shown in FIG. 5 or 6. The light in lighting panel 4 is reflected by the prisms 4d or 4e and discharged from the discharge surface 4c.

The light from the lighting panel 4 transmits the color LCD 5 and is reflected by a reflector 7. The reflected light transmits the color LCD 5 again, and transmits the lighting panel 4.

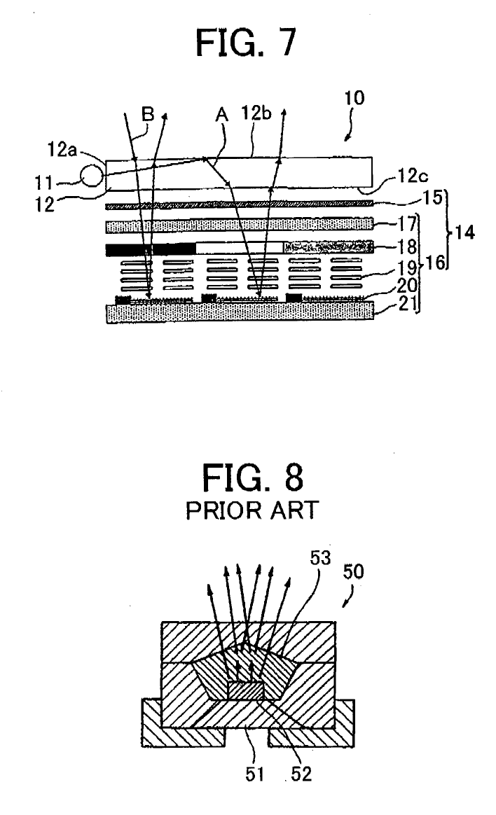

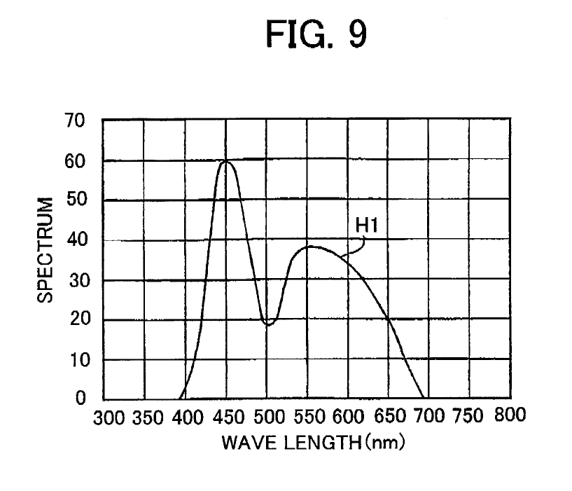

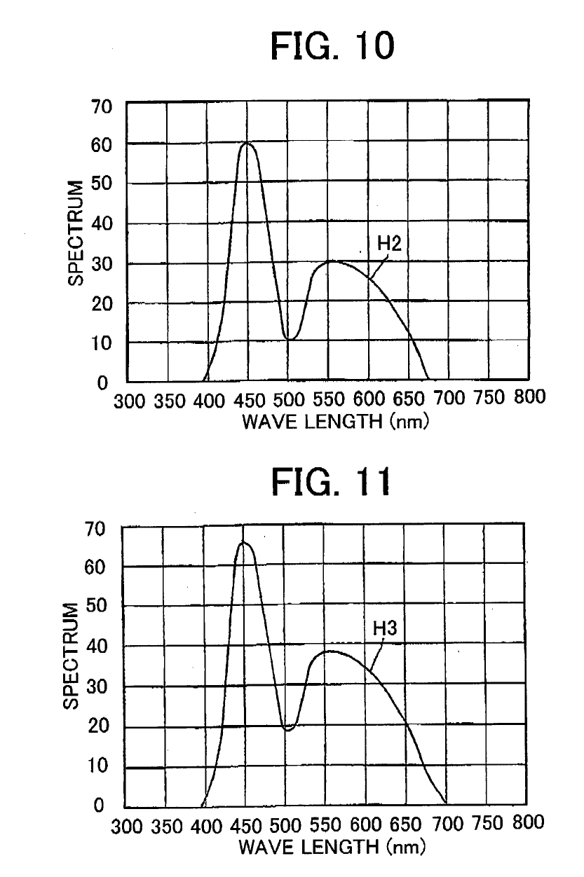

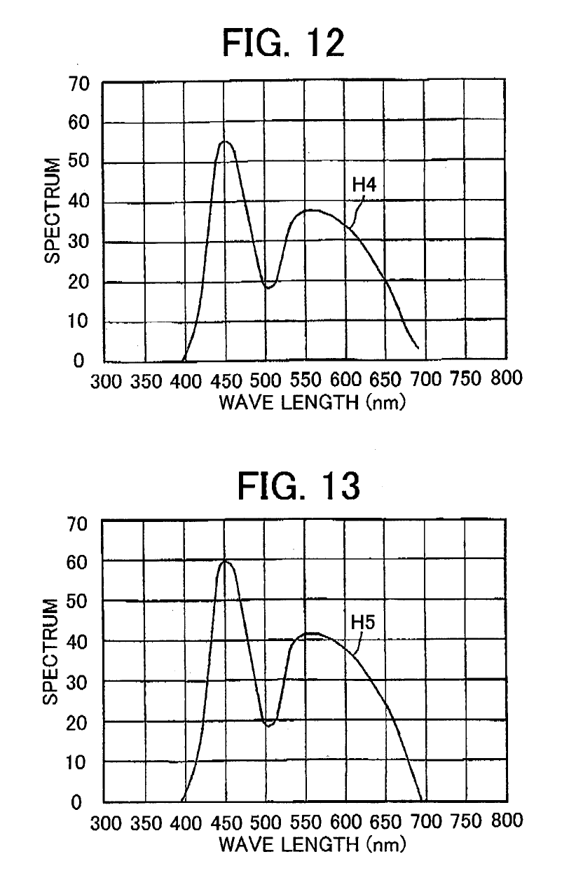

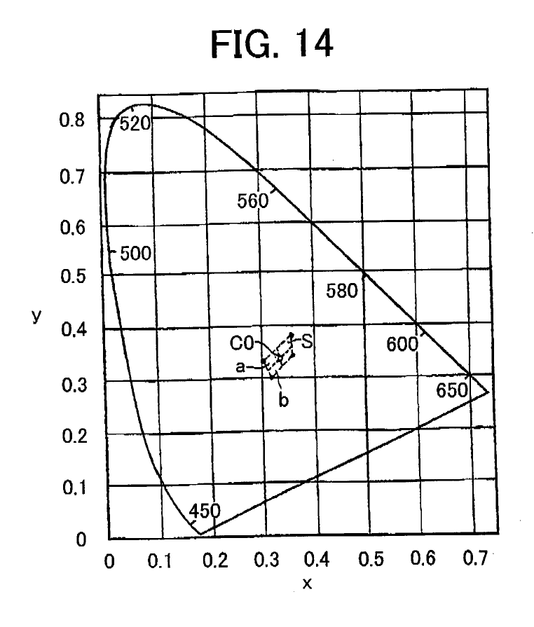

Referring to FIG. 7 showing the second embodiment of the present invention, an illumination device 10 comprises a white LED 11, a lighting panel 12, and a color LCD 14. The lighting panel 12 in made of transparent resin and has an incident surface 12a, a reflection surface 12b having a plurality of prisms (not shown), and a discharge surface 12c. An interference filter (not shown) is provided on the discharge surface 12c. The color LCD 14 comprises a polarization plate 15 and a liquid crystal cell 16. The cell 16 comprises an upper glass substrate 17, a color filter 18, a liquid crystal 19, a reflection plate 20, and a lower glass substrate 21.

The lights emitted from the LED 11 enter the lighting panel 12 from the incident surface 12a. The light A in lighting panel 12 is reflected by the prisms on the reflection surface 12b and discharged from the discharge surface 12c, passing through the interference filter on the discharge surface. Thus, the color of the light emitted from the LED 11 is corrected to proper white by the interference filter.

The light from the lighting panel 12 transmits the color LCD 14 and is reflected by the reflection plate 20. The reflected light transmits the color LCD 14 again, and transmits the lighting panel 12.

When the luminous intensity of atmospheric light B is high, the white LED 11 is not used.

In accordance with the present invention, the chromaticity of the light emitted from the LED is corrected by the interference filter to desired white, so that the color LCD may display a natural image.

While the invention has been described in conjunction with preferred specific embodiment thereof, it will be understood that this description is intended to illustrate and not limit the scope of the invention, which is defined by the following claims.

What is claimed is:

1. An illuminating device comprising:
an LED;
a lighting panel provided corresponding to the LED for guiding light emitted from the LED to illuminate an LCD; and
an interference filter provided on a surface through which the light from the LED passes so as to correct chromaticity of the light.

2. The device according to claim 1 further comprising a light guide rod provided between the LED and the lighting panel so as to guide the light from the LED to the lighting panel.

3. The device according to claim 1 wherein the lighting panel is disposed above the LCD.
